(19) United States
(12) Patent Application Publication
(10) Pub. No.: US 2014/0278969 A1
(43) Pub. Date: Sep. 18, 2014

(54) DERIVATIVE MEDIA CONTENT

(71) Applicant: ECHOSTAR TECHNOLOGIES L.L.C., Englewood, CO (US)

(72) Inventors: Nicholas B. Newell, Highlands Ranch, CO (US); Omar A. Khan, Englewood, CO (US)

(73) Assignee: ECHOSTAR TECHNOLOGIES L.L.C., Englewood, CO (US)

(21) Appl. No.: 13/800,631

(22) Filed: Mar. 13, 2013

(51) Int. Cl. G06Q 30/02

(52) U.S. Cl. CPC G06Q 30/0276
USPC 705/14.53

(57) ABSTRACT

A media device is configured to identify an indicia of user interest in at least one media content attribute. At least one segment of an item of media content that is associated with the indicia of interest is identified. An item of derivative content that includes the at least one segment is generated.

### BACKGROUND

Consumers of media content, such as video content, may be presented with trailers to entice purchase of media content. For example, typical movie trailers may include a predetermined sequence of media content, e.g., a series of frames from a movie, and are usually distributed in a defined geographic area, e.g., regionally, nationally, etc., to media outlets to advertise a film. The predetermined sequence may be generated by a movie studio to reach a wide audience, and generally lacks customization. Thus, a movie trailer may be enticing to one consumer but may not generate any interest in another consumer, or may not highlight features of interest to any particular consumer. Thus, while current trailers may be simple to distribute, their effectiveness is often limited.

Unfortunately, the costs and time presently required for trailer development usually preclude customizing a trailer for smaller audiences and/or individual consumers. Further, current media content delivery systems often send one or even many copies of a particular trailer to consumers in addition to media content to which the trailer is related. Sending a trailer for an item of media content in addition to the item of media content itself results in inefficient bandwidth consumption in a content delivery system. In general, present content delivery systems lack mechanisms for creating custom trailers and/or different trailers for different audiences.

### DRAWINGS

FIG. 1 is a block diagram of an exemplary media content delivery system.

FIG. 2 is a block diagram of exemplary media content.

FIG. 3 is a block diagram of exemplary derivative content.

FIG. 4 is a diagram of an exemplary process for generating derivative content.

FIG. 5 is a diagram of an exemplary process for collecting user data.

FIG. 6 is a diagram of an exemplary process for collecting derivative content information.

FIG. 7 is a diagram of an exemplary process for distributing derivative content.

FIG. 8 is a diagram of an exemplary process for presentation of derivative content.

FIG. 9 is a diagram of an exemplary process for rating derivative content.

### DETAILED DESCRIPTION

### Introduction

FIG. 1 is a block diagram of an exemplary media content delivery system 100. A media source 101 in the system 100 includes media content 102, e.g., a video presentation such as a movie. The media content 102 may be provided via a network 115 to a media device 120. The media device 120 is generally located in a customer premises 119. Using various data related to the media content 102 as described herein below, the media device 120 can generate derivative content 125 that is derived from and related to the media content 102. For example, derivative content 125 can be used as a custom movie trailer or the like displayed to a user of the media device 120. The derivative content 125 may be generated, generally by extracting and/or modifying media data 103 in the media content 102, before, or during, presentation of related media content 102 via a media device 120.

Accordingly, user interests and tastes may be accounted for to generate derivative content 125 such as a custom trailer for an item of media content 102 such as a movie. Further, data identifying the derivative content 125 generated, and reporting whether a user purchased an item of media content 102, e.g., a movie, associated with the derivative content 125, may be sent back to be stored in the media source 101 as customer premises user data 109. Derivative content 125 generated on a first media device 120 may be shared with one or more second media devices.

The media content 102 may be displayed to a user via the media device 120 and/or a media display device 121 such as a television, video monitor, mobile telecommunications device, tablet, or the like. When content 102 is referred to herein as being “displayed,” it is to be understood that such display could include any possible mode of displaying media data, such as a display of visual data, audio data, etc. For example, content 102 could be displayed by showing video or image data on a screen with or without sound.

### Exemplary System Elements

### Media Source

In general, media source 101 may include multiple elements for processing, storing, and providing media content 102 and related data. Elements of the system 101 may be local to one another and/or may be distributed amongst multiple locations. For example, media source 101 may include computer servers and data storage devices, e.g., for storing and processing content 102 and other data such as discussed herein.

In general, the media source 101 may be any one or some combination of various mechanisms for delivering media content 102, e.g., one or more computing devices and storage devices, and may depend on a type of media content 102 being provided. By way of example and not limitation, media content 102 data may be provided as video-on-demand through a cable, satellite, or internet protocol television (IPTV) distribution system, as streaming Internet video data, or as some other kind of data. Accordingly, the media source 101 may include one or more of a cable or satellite television headend, a video streaming service such as generally includes a multimedia web server (or some other computing device), or some other mechanism for delivering multimedia data. In general, examples of media content 102 include various types of data, including audio, video, images, etc.

Communications to and from the media source 101, customer premises 119, and one or more remote sites 130 may occur via a network 115. In general, the network 115 represents one or more mechanisms for delivering content 102 from the media source 101 to a media device 120. Accordingly, the network 115 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks, local area networks (LAN) and/or wide area networks (WAN), including the Internet, etc.

Media content 102 is generally delivered via the network 115 in a digital format, e.g., as compressed audio and/or video data. The media content 102 generally includes, according to such digital format, media data 103 and content metadata 104. For example, MPEG refers to a set of standards generally promulgated by the International Standards Organization/International Electrical Commission Moving Picture Experts Group (MPEG). H.264 refers to a standard promulgated by the International Telecommunications Union (ITU). Accordingly, by way of example and not limitation, media content 102 may be provided in a format such as the MPEG-1, MPEG-2 or the H.264/MPEG-4 Advanced Video Coating standards (AVC) (H.264 and MPEG-4 at present being consistent), or according to some other standard or standards. For example, media content 102 could be audio data formatted according to standards such as MPEG-2 Audio Layer III (MP3), Advanced Audio Coding (AAC), etc. Further, the foregoing standards generally provide for including metadata, e.g. content metadata 104, along with media data 103, in a file of media content 102, such as the content metadata 104 discussed herein.

Media content 102 includes media content as it is usually provided for general distribution, e.g., a movie, television program, video file, audio file, etc. in a form has provided by a distributor of the media content 102. Alternatively or additionally, media content 102 may be modified from the form provided by a general distributor of content (e.g., recompressed, re-encoded, etc.). The media data 103 includes data by which a display, playback, representation, etc. of the media content 102 is presented on a media device 120 and/or display device 121. For example, media data 103 generally includes units of encoded and/or compressed video data, e.g., frames of an MPEG file or stream.

Content metadata 104 may include metadata as provided by an encoding standard such as an MPEG standard. Alternatively and/or additionally, content metadata 104 could be stored and/or provided separately to a media device 120, apart from media data 103. In general, content metadata 104 provides general descriptive information for an item of media content 102. Examples of content metadata 104 include information such as content 102 title, chapter, actor information, Motion Picture Association of America MPAA rating information, reviews, and other information that describes an item of media content 102. Information for metadata 104 may be gathered from a content producer, e.g., a movie studio, media information aggregators, and other sources such as critical movie reviews. Further, content metadata 104 may identify a director, producer, screenwriter, star rating, awards, critical reviews, voice-over, story slides, story text, story animations, studio animation for the movie, etc.

Clip-level metadata 105 is generally associated with an item of media content 102. By matching time indexes and/or tags in clip-level metadata 105 with information in collected user data 123, as described further below, clip-level metadata 105 may be used to generate derivative content 125 that includes one or more segments of media data 103. Accordingly, a record or instance of clip-level metadata 105 generally includes an identifier associating the clip-level metadata 105 with the item of media content 102. Alternatively and/or additionally, the clip-level metadata 105 could be included in an item of media content 102, e.g., in a file or collection of files that comprise the media content 102.

Further, the clip-level metadata 105 generally identifies subsets or particular segments of media data 103, and may further associate attributes, e.g., keywords or tags that describe a characteristic of a scene in a movie, with a segment of media data 103. For example, clip-level metadata 105 may include time indexes or pointers to a location or locations in media data 103 that identify a particular segment of media data 103 for which the metadata 105 should be applied. In an example, clip-level metadata 105 may indicate a segment starting at time index 00:45:10 (45 min. and 10 seconds) and ending at 00:47:45 (47 min. and 45 seconds).

Attributes descriptive of a segment of media data 103 indicated, e.g., pointed to, by the clip-level metadata 105 may, for example, be stored as tags included in a record or instance of clip-level metadata 105. Such attributes or tags could, to provide just a few examples, include items such as “action sequence,” “fight scene,” “love scene,” “slapstick,” etc. That is, clip-level metadata 105 may include information that can then be associated with a segment of media data 105 to indicate that the segment should be used in derivative content 125, e.g., a clip or trailer, such as an identification of actors in a scene, a type of scene (e.g., action), a location (e.g., Chicago), a genre, a mood, an intensity (e.g., “mature”), a length, music details (e.g., “hard rock”), whether dialogue is present, etc. Accordingly, a non-limiting example of a record of clip-level metadata 105 could include an identifier for an item of media content 102, starting and ending time indexes along with one or more descriptive tags, e.g., {content_ID_{—}403245, 0:10:32, 0:11:02, “action sequence,” “fight scene,” “Chicago”}.

Mandatory content data 106 may identify portions of media data 103 in an item of media content 102, e.g., a video scene, particular music, etc., that is required for inclusion in any preview, summary, trailer, etc. of the media content 102. For example, a distributor such as a studio may mandate certain scenes or sequences for inclusion in a trailer for a movie item of media content 102. Continuing the example where the media content 102 is a movie, a thrilling action sequence may be identified by mandatory content data 106 such that the thrilling action sequence is to be included in every trailer for the movie media content 102, including a custom trailer included in derivative content 125 generated at media device 120. Moreover, additional content 107, e.g., music that may or must be added to the trailer may be identified by mandatory content data 106. Other requirements, e.g., a minimum or maximum trailer length, may also be specified.

In general, additional content 107 may include alternate or additional content that may be included in derivative content 125, but that is not found in media data 103. This may include, for example, one or more music tracks the may be desirable to overlay with media data 103 in generating the custom trailer. Other information, such as MPAA ratings, messages to consumers, and alternative video not found in media data 103 may be included in additional content 107 for use in generating the custom trailer.

Predefined content data 108 generally includes data that specifies parameters for generating a set of predefined content, e.g., a predefined or “standard” trailer, at the media device 120 from an item of media content 102. For example, predefined content data 108 may include pointers or time indices to locations in media data 103 for inclusion in a set of predefined content, e.g., such as might be used for a movie trailer. The predefined content data 108 also generally includes an identifier for an item of media content 102, and information for ordering identified segments of media data 103, etc.

In general, media device 120 may download and store media content 102 on a schedule such that popular items of media content 102, e.g., movies, are available immediately to the consumer. However, downloading previews, summaries, etc. such as standard trailers, in addition to items of media content 102, generally consumes extra and sometimes large amounts of bandwidth on network 115. For example, a movie trailer may be a large and bandwidth-intensive MPEG file. In contrast, predefined trailer data 108 generally includes a relatively small amount of metadata and the like. Generation of a standard trailer at media device 120 thus provides efficiencies to the system 100 with respect to consumption of resources such as bandwidth, processing, and memory consumption. The predefined trailer data 108 can then be used by media device 120 to generate a standard trailer where derivative content 125 is not used, or should not be used (e.g., due to lack of information such as where collected user data 123 is not available, or content metadata 104 has not been received).

Customer premises user data 109 may include information about consumers that utilize media device 120 and/or an associated customer premises 119. User data 109 can describe generally the usage history of media device 120, or may describe an individual's use of media device 120, or both. For example, where “favorite lists” are provided by media device 120, users that generally make selections from a favorites list may have user data collected separately from the user data collected for media device 120 as a whole, e.g., for all consumers in a customer premises 119. The user data 109 may be received from various sources including account and billing information, as well as reporting from media device 120 as to the viewing preferences and habits of a user or users of a media device 120. For example, the media source 101 could receive and store some or all of the collected user data 123, described further below, from a media device 120 for inclusion in customer premises user data 109. Further, the user data 109 could be collected and possibly aggregated for multiple media devices 120 in a customer premises 119.

User data 109 may further include information reported to a media source 101, e.g., stored in a data store of the media source 101, from a media device 120, and possibly multiple media devices 120, in one or more customer premises 119. User data 109 generally includes information concerning generation and/or use of derivative content 125 by one or more users. The user data 109 may include information relating to how derivative content 125, e.g., a custom trailer, was generated. For example, the data 110 may include time indexes for media data 103, related collected user data 123 (e.g., user data collected by media device 120), user data 109 (i.e., user data collected by media source 101, discussed further below), and other information that was used to generate the derivative content 125. Moreover, reported user data 109 may indicate whether a user, i.e., a consumer, purchased media content 102, e.g., a movie, related to the derivative content 125, how long a user viewed the content 125 such as a custom trailer, and what content 102, if any, the user ultimately purchased. The user data 109 for an item of derivative content 125 may also indicate whether content 102 purchased or viewed by a user was related to the item of derivative content 125.

Collected derivative content 110 may be included in a data store of the media source 101. For example, a media device 120 may generate an item of derivative content 125 as described herein. Such item of derivative content 125 may be provided for display within the customer premises 119, but may also be of interest for users of other media devices 120. Accordingly, collected derivative content 110 includes metadata identifying an item of media content 110 along with data sufficient for a second media device 120 to create an indicated item of derivative content from the collected derivative content 110. For example, in addition to a media content 102 identifier, the collected derivative content 110 could include time indexes, pointers, or the like, to locations in the media content 102 from which the indicated derivative content 110 could be recreated by a second media device. The collected derivative content 110 could also include attributes, e.g., tags or the like, of the indicated derivative content 125. Accordingly, an item of derivative content 125 generated by a media device 120 may be provided for other possible uses, e.g., provision to other media devices 120.

### Customer Premises

Turning to the customer premises 119, the media device 120 is generally a device including a computer processor and associated storage, e.g., volatile memory, nonvolatile memory, etc., and capable of communicating via the network 115. Exemplary media devices 120 include a set-top box, a personal computer such as a laptop, handheld, or tablet computer, a smart phone, etc. Further, the media device 120 may be connected to a display device 121, e.g., a television, or may incorporate a display device 121, e.g., a display of a personal computer. When content 102, 125, etc. is referred to herein as being “displayed,” it is to be understood that such display could include any possible mode of displaying media data, such as a display of visual data, audio data, etc. For example, content 102, 125, etc. could be displayed by showing video or image data on a screen with or without sound, by playing audio data with or without a visual display, etc.

Local content 122 includes content 102 downloaded from the media source 101 by the media device 120. Local content 122 may also include additional content 107 downloaded from the media source 101. Accordingly, the content 122 may be stored on a disk or other storage of the media device 120, or in storage accessible to the media device 120, e.g., via a wired or wireless local area network. Further, local content 122 could be obtained from such storage without having been downloaded from the media source 101. For example, the media device 120, or some other storage accessible via a local network, could include a “music library” or the like including audio files; a user's preferred or “favorite” audio files, e.g., sorted according to genre, user ratings, and/or artist, etc., could be included in local content 122. Additionally or alternatively, local content 122 could be stored remotely, such as in a cloud application, and made accessible to the media device 120.

Collected user data 123 may include information collected locally at media device 120 related to media consumption habits of one or more users in a customer premises 119, and/or the customer premises as a whole. For example, collected user data 123 may include channels viewed, items of media content 102 such as movies or television shows viewed, a day of the week and/or times of day channels and/or media content 102 are viewed, channel hopping information, and other more detailed information about use of media device 120. Further, the user data 123 may include attributes relating to media content 102 accessed and/or viewed by a user. Such attributes may be represented by tags or the like describing some or all of the media content 102. For example, a tag could indicate “action sequence,” “violent scene,” “scary scene,” “slapstick,” etc. An attribute, possibly together with ratings or the like for an attribute, thus constitutes an indicia of user interest that may be used to provide derivative content 125. As discussed further below, derivative content 125 may be generated at least in part by matching tags in collected user data 123 with tags in clip-level metadata 105.

Log data 124 may be stored by the media device 120 when a user of the media device 120 accesses an item of media content 120. For example, a user may watch a particular movie, or trailer for a movie. The fact that the movie was watched, an amount of the movie that was watched, a time or times when the movie was watched, etc., could all be included in log data 124. When an item of derivative content 125 is viewed, for example, the log 124 may reflect what item was viewed, what time indexes of the item of derivative content 125 were viewed, and whether the user purchased related content, e.g., a movie after viewing the item of derivative content 125. Further, log data 124 may include an identifier for a particular user of the media device 120 in one or more records logging user activity.

In addition to an identifier for an item of media content 102 with respect to which a log 124 record is created, the log data 124 could also include information taken from content metadata 104, such as media content 102 title, keywords or tags describing the media content 102, names of actors, locations, and other attributes identified with the media content. Including information from metadata 104 in the log data 124 may not be necessary, but may allow for more efficient use of log data 124 in generating user data 123 as described below with respect to FIG. 5.

Derivative content 125 may include custom trailers generated from media data 103 and/or local content 122. Accordingly, the derivative content 125 may be an MPEG file or the like, and may be stored in a memory or storage of the media device 120. Derivative content 125 may be generated prior to any request for the derivative content 125, e.g., according to a scheduled time or some other trigger, or may be generated substantially contemporaneously with a request for viewing a trailer, preview, or the like, of an item of media content 102. A process for generating derivative content 125 is described in more detail below with respect to FIG. 4. Note that, although derivative content 125 is shown in the exemplary system 100 as being generated and stored by the media device 120, derivative content 125 could be generated and/or stored remotely from the media device 120. For example, collected user data 123 could be provided to a computing device included in the media source 101, which could then perform operations described herein to the media device 122 generate derivative content 125.

### Remote Sites

A remote site 130 may include a social media site, an e-commerce site, a news site, a site providing reference information, etc. Generally, a user account on a remote site 130 can be accessed by a user login identifier and password. In general, remote user data 135 may be used to identify likes and dislikes for inclusion in collected user data 123. For example, media device 120 could include instructions for accessing and querying a user's account on a remote site 130. The media device 120 could determine if tags, keywords, or the like were associated with the user account. For example, a Facebook or Twitter account could include “likes,” “tweets,” etc. including such tags or keywords that could be stored in collected user data 123 for a user.

### Media Content and Derivative Content

FIG. 2 is a block diagram of an exemplary item of media content 102 and associated clip-level metadata 105 and mandatory content data 106. As stated above, media data 103 is typically an encoded (e.g., MPEG) video stream or file. Clip-level metadata 105 identifies one, or, as in the example of FIG. 2, a plurality, of segments in media data 103. Mandatory content data 106 in the example of FIG. 2 identifies one segment of media data 103, although more segments could be identified by the mandatory content data 106.

As discussed above, the clip-level metadata 105 at a minimum includes time indexes, pointers, or the like by which a segment of media data 103 may be identified. Further, the clip-level metadata 105 may include attribute information such as a tag or tags descriptive of the identified media data 103 segment. Mandatory content data 106 generally also includes time indexes, pointers, etc. to a segment of media data 103. Note that, depending on the encoding for media data 103, a decoder such as may be included in a media device 120 may need to decode portions of the data 103 beyond the time indexes referenced by clip-level metadata 105 and mandatory content data 106 in order to generate derivative content 125.

As shown, mandatory content data 106 overlaps a first instance of clip-level metadata 105. Where a conflict exists between mandatory content data 106 and a clip-level metadata 105, the mandatory content data 106 preempts the clip-level metadata 105, i.e., a first segment specified by clip-level metadata 105 will not be used where that segment overlaps with a second segment specified by mandatory content data 106.

FIG. 3 is a block diagram of an exemplary derivative content generation 300. Derivative content 125 includes content extracted from an item of media content 102, i.e., one or more content segments 305 that are selected segments of media data 103. The segments 305 are generally selected according to clip-level metadata 105 and/or mandatory content data 106. Moreover, alternate content 107 may be added to the generated derivative content 125. Additional content 107 may include generally any type of media data, for example, audio or music. The alternate content 107 may be appropriate for addition or replacement of audio, video, images, etc. of segment 305. For example, alternate content 107 may include an exciting music ensemble. This may then be added with the audio from a trailer generated from stream 110, adding continuity when the trailer is viewed, as well as adding excitement. Where content 110 includes a first audio track (English) and a second audio track (Spanish), the system may merge alternate content 107 into the selected audio track. If, for example, English is used based on the locale selection of media device 120, then alternate media device 120 may merge the first audio track with alternate content 107 to generate a new audio track for derivative content 125.

As shown in FIG. 3, alternate content 107 may be overlaid with assembled segments 305. For example, a music file could be selected to be played as long as segments 305 are played. Likewise, other data could be overlaid on segments 305, e.g., information to put on top of a segment (i.e., story text or voiceover). In this case, the alternate content is linked to a clip with a common identifier that exists in both the clip-level metadata and the alternate content metadata. In a variation, overlaid alternate content 107 could be other data, e.g., an audio file including a voice-over, images and/or textual data, etc. that could include an identifier. e.g., a tag or the like, that can be associated with an identifier such as a tag in clip-level metadata 105. Thus, alternate content 107 could include one or more files overlaid on one another and/or segments 107, and that could be arranged in a sequence to accompany segments 305 extracted from media according to a matching or association of one or more identifiers in the alternative content 107 with one or more identifiers in the clip-level metadata 105.

A further example of alternate content 107 includes one or more segments 305 provided in the alternate content 107 rather than being taken from media data 103. For example, the left-most segment 305 shown in FIG. 3 could be a content producer's introduction (e.g., an animation identifying a movie studio) rather than units of media data 103. The media device 120 could include an instruction to look for an “intro” tag or the like in alternate content 107 identifying a segment 305 to be inserted at the beginning of derivative content 125. Other tags or identifiers could be used to specify alternate content 107 to be inserted at various locations in derivative content 125.

In general, derivative content generation 300 may use clip-level metadata 105, mandatory content data 106, collected user data 123, predefined trailer data 108, user data 109, and/or other information to select segments of media data 103 to use as segments 305 in derivative content 125. The forgoing data, in addition to alternate content data 107, may be used to select an alternate content overlay 107.

### Exemplary Process Flows

FIG. 4 is a diagram of an exemplary process 400 for generating derivative content 125. The process 400 may be executed according to instructions stored in a memory of the media device 120. However, as noted above, some or all of the process 400 could be executed in other manners, e.g., according to instructions stored and executed by a computing device in the media source 101.

In any event, the process 400 begins in a block 405 in which user data 123, described above, is collected from media device 120, one or more remote sites 130, and/or user data 109. Collection of user data 123 is described in more detail below with respect to FIG. 5.

Next, in a block 410, media device 120 receives an item of media content 102, including media data 103 and metadata 104, from media source 101. The item of media content 102 may be stored and/or accessed as local content 122. Media content 102 may be received from the media source 101 in a variety of ways. For example, the media content 102 may be provided in one or more manners described above, e.g., as a programming channel in a satellite or cable television system, or as video-on-demand in such a system. In some cases, e.g., video-on-demand, media content 102 may be pushed to the media device 120 from the content source 101 to be available for user purchase, or video-on-demand media content 102 may be retrieved from the content server 140 when purchased. Further, media device 120 could receive media content 102 as a download of media data via a network, such as the Internet.

In addition, clip-level metadata 105 associated with the item of media content 102 is generally provided in the block 410. Mandatory content data 106, additional content 107, and/or predefined content data 108 associated with the media content 102, are also generally provided in the block 410, to the extent data 106, 107, and/or 108 exists with respect to the media content 102.

Next, in a block 415, the media device 120 determines attributes for media content 102 that may be of interest to a user of the media device 120. For example, the media device 120 may query collected user data 123 to obtain a tag or tags indicating such user interest.

Next, in a block 420, the media device 120 queries clip-level metadata 105, e.g., generally included in local content 122 associated with a downloaded item of media content 102, although the media device 120 could query clip-level metadata 105 stored in the media source 101. In any case, the media device 120 identifies a tag or tags in the clip-level metadata 105 that may indicate subject matter of an item of media content 102.

Next, in a block 425, the media device 120 selects one or more segments 305 such as shown in FIG. 3 from media data 103 to be included in an item of derivative content 125. Such selection of segments 305 may be performed by matching tags from clip-level metadata 105 with tags in user data 123. In general, segments 305 are assembled in derivative content 125 in a same order as the segments 305 are taken from media data 103, although the segments may be rearranged, e.g., as described below.

It is to be understood that for tags or information in clip-level metadata 105 to “match” tags or other information in user data 123 may mean that there is an exact match, but could also mean that media device 120 includes instructions for determining that tags match when certain overlapping words or phrases exist within the tags, when the tags include synonyms or the like, or where other rules or data indicate that a match should be found. For example, where collected user data 123 indicates that the user has prior purchases of action movies, e.g., includes multiple instances of an “action” tag, and where the user has made prior purchases of movies including the actor Bruce Willis (who may be indicated by an additional “Bruce Willis” tag), a rule may indicate that and “action” tag and a “Bruce Willis” tag should be deemed to match, whereupon the media device 120 may match such tags in clip-level metadata 105 to the tags in the user data 123.

Next, in a block 430, mandatory content data 106, if any, for the media content 102 item is applied to the item of derivative content that was generated in the block 425. For example, as discussed above, mandatory content data 106 may indicate that a portion of media data 103 overlapping with a segment 305 indicated by clip-level metadata 105 must be included in any derivative content 125. Accordingly, the segment 305 overlapping with the indicated mandatory portion of media data 103 may be replaced in the derivative content 125 with the mandatory portion of the media data 103. Further, the derivative content 125 may be modified with any other constraints imposed by mandatory content data 106, e.g., a maximum time duration, etc.

Next, in a block 435, segments 305 in the assembled derivative content 125 may be reordered according to rankings or ratings of the various segments 305. An example of reordering may include that a segment 305 appearing at a later point in media data 103 may have a higher ranking, e.g., taken from a rating for an attribute included in user data 123, when compared to segments 305 that appear at earlier points in the media data 103. In this case, the derivative content 125 may be reordered so that the highest-ranked segment 305 appears near or at the beginning of the derivative content 125. Reordering segments 305 may be desirable when the user may only experience, e.g., view, a brief period of play before terminating display of derivative content 125, meaning that the highest-ranking segment or segments 305 should be at or near a beginning point of the derivative content 125 to maximize the likelihood that a user will view the highly-ranked segment 305.

Next, in a block 440, alternative content 107 is applied to the derivative content 125. As noted above, alternative content 107 may be specified to be added to, or to replace, some or all of an item of derivative content 125.

Next, in a block 445, the media device 120 receives a request to display derivative content 125, e.g., for content preview such as a movie trailer. The request may be a request from a user, e.g., initiated via a remote control, user interface, etc. of the device 120, or may be triggered by some other mechanism, such as a default trailer to be shown when the user selects an on-demand menu feature. Note that the request for derivative content 125 could be received at other points in the process 400, e.g., before or immediately after media content is received as described above concerning the block 405.

Next, in a block 450, the device 120 displays the derivative content 125. For example, the media device 120 may play back derivative content 125 as a trailer in a user interface provided by media device 120, e.g., via the display device 121. The playback may be performed by media device 120 itself, or it may be played back by another device in the system (e.g., where display device 121 is a “smart TV” that may include Digital Living Network Alliance (“DLNA”) functionality).

Next, in a block 455, media device 120 may collect user feedback (although user feedback is not collected in some implementations). For example, feedback may be solicited from a user via a user interface of media device 120. In some cases, a decision whether to collect feedback may be based on information stored in mandatory content data 106, and may also be determined according to other factors such as a time of day, whether feedback has been solicited within a predetermined previous amount of time, and whether the user has attempted to cancel feedback in the past.

In any case, questions regarding feedback may be included in mandatory content data 106, or the question(s) may be stored on media device 120, e.g., provided by media source 101. A simple example may include a request from the user to rate derivative content 125 based on a 1 to 10 scale. Alternatively, questions may be presented to the user and response(s) solicited in the form of yes or no answers. Such information may be useful to a content provider, producer (e.g., movie studio), etc.

Next, in a block 460, information related to the derivative content 125 is logged at media device 120, and/or reported back to a media source 101. Where log data 124 is stored locally at media device 120, the log data 124 may include information such as whether or not the user viewed the entire derivative content 125, the time and date of trailer generation, the time and date of the trailer display, what arrangement of clip-level metadata 105 was included in the trailer, and the ranking of clip-level metadata 105, discussed above. Media device 120 may then report the information to media source 101, wherein may be stored as customer premises user data 109. Further details of a process for utilizing customer premises user data 109 are provided below with respect to FIG. 6.

Next, in a block 465, the derivative content 125 may be provided to the media source 101, wherein may be stored as collected derivative content 110.

Following the block 465, the process 400 ends.

FIG. 5 is a diagram of an exemplary process 500 for collecting user data 123. The process 500 begins in a block 505, in which a user is presented with a survey. For example, a media device 120 could include instructions for presenting a user with an interface providing various questions, e.g., an input form whereby a user could indicate key words, phrases, tags, etc. of interest to a user. Such survey could be part of a feedback process such as described above with respect to block 455 of the process 400, but the media device 120 could also provide a separate interface for user survey data to be gathered. For example, a user could be asked to rate or rank various genres, categories, actors, movies, etc., to generate information for user data 123. For example, if a user highly rated or rated a particular genre, e.g., romantic comedies, then the tag or phrase “romantic comedy” could be added to user data 123, possibly along with an indication of the user's rating of the genre.

Next, in a block 510, log data 124 is queried to obtain information concerning media content 102 that a user of the media device 120 has previously consumed. The log data 124 may include information about the media content 102, e.g., information from metadata 104, as described above, or the media source 101 may be queried for such information. In general, the log data 124 may be used to obtain media content 102 attributes of interest to a user. For example, if a user has watched a large number of movies with a “suspense” attribute, then that attribute may be added to user data 123 in association with the media device 120 and/or a particular user of the media device 120.

Next, in a block 515, customer premises user data 109, generally stored in the media source 101 is described above, is queried to obtain further media content 102 attributes of interest to a user of the media device 120. Any additional attributes, e.g., tags or the like, may be stored in the user data 123, possibly in association with a particular user's identifier.

Next, in a block 520, one or more remote sites 130 may be queried for remote site user data 135. As discussed above, remote site user data 135 may be parsed or mined to obtain keywords, tags, etc. indicative of a user's interests. Such tags or the like may be added to the user data 123.

The process 500 ends following the block 520.

FIG. 6 is a diagram of an exemplary process 600 for utilizing customer user data 109.

The process 600 begins in a block 605 where user data is collected from one or more media devices 120, e.g., as described above with respect to the block 460 of FIG. 4. For example, media devices 120 may provide log data 124 and/or other information to the media source 101.

Next, in a block 610, log data 124 or other information provided in the block 605 is aggregated by media source 101. For example, log data 124 may be aggregated according to a user, a geographic area of a customer premises 119, a time of day, the user gender, a user age, etc. Further, log data 124 may be aggregated for inclusion in user data 109 according to specific segments 305 included in an item of derivative content 125, or other information about media content 100 that was accessed by a user. Aggregation of data 109 is helpful for drawing conclusions about users and to create subsets of similar users, such that the system in general can find commonalities in the types of content desired. Moreover, subsets of similar users may be identified and information (e.g., clip-level metadata 105 that has been successful in enticing purchases of movies) pushed to their media devices 120 for use in generating derivative content 125.

Next, in a block 615, the content metadata 104 in media content 102, and other data 105, 106, 108, 110, 107 stored by media source 101, may be updated. For example, information concerning clip-level metadata 105 used to identify segments 305 may be used to update predefined content data 108. That is, segments 305 shown to be of interest to users may be desirable for inclusion in predefined content 108, e.g., a “standard” movie trailer. Similarly, if clip-level metadata 105 has a very high response, mandatory content data 106 may be modified to include the segment of media data 103 identified by that clip-level metadata 105.

Accordingly, data 105, 106, etc. stored by media source 101 may be improved by the collection of data collected from media device 120. In one example, where a particular item of derivative content 125 has a high conversion rate (e.g., above a predetermined threshold), i.e., a rate of purchase once a user has seen the derivative content 125, media source 101 may determine that one or more segments 305 from the derivative content 125 should be included in the predefined content data 108. If the conversion rate is high enough (e.g., above a predetermined threshold), then such segments could even be added to mandatory content data 106.

Following the block 615, the process 600 ends.

FIG. 7 is a diagram of an exemplary process 700 for distributing derivative content 125.

The process 700 begins in a block 705, in which similar users are identified from the user data 109. For example, where viewing habits are similar, demographic information such as age, geographic location, etc., users, may be identified as a group. This group may then have common interests and the metadata stored by media source 101 may be adjusted for the group in particular. It should be understood that multiple groups may, and likely will, be determined, and that characteristics, e.g. demographic data, for each group may have similarities and dissimilarities.

Next, in a block 710, one or more items of derivative content 125, e.g., stored in collected derivative content 110, are identified as relevant to one or more media devices 120 associated with users identified in the block 705. For example, a provided item of derivative content 125 may have attributes, e.g., tags, matching tags associated with the group identified in the block 705.

Next, in a block 715, media source 101 determines whether a default set of content, e.g., a default movie trailer, (typically identified by predefined content data 108 and/or mandatory content data 106) may be replaced at one or more media devices 120 associated with users in the group identified in a block 705. If the default content may be replaced, control proceeds to step 720. If the default content should not be replaced, the process 700 ends.

In a block 720, media source 101 may distribute derivative content 125 and/or metadata therefor to media devices 120 associated with users identified above in the block 710. Most often the media source 101 need only distribute metadata for distributive content 125, from which media devices 120 can create the distributive content 125, e.g., in a manner described above, from media content 110 provided to a respective media device 120. However, it is also possible that a complete file of derivative content 125 could be provided in this block 720.

The process 700 ends following the block 720.

FIG. 8 is a diagram of an exemplary process 800 for presentation of derivative content 125.

The process 800 begins in a block 805 in which derivative content 125 stored at a media device are ranked. Media device 120 may generate trailers for multiple items of media content 102 that may be received from a media source 101. The derivative content may be stored by the media device 120, e.g., as local content 122. In general, a ranking of derivative content may provide an ordered list of trailers to be presented to the user. Such ranking may be performed according to tags, keywords, etc. indicated in user data 123 to be of interest to the user. Further details concerning rating and ranking derivative content 125 are provided below with respect to FIG. 9. For example, where collected user data 123 includes a large percentage of “Bruce Willis” movies watched, the system may rank scenes described by clip-level metadata 105 as including “Bruce Willis” (e.g., with tags indicating “Bruce Willis” is in a particular scene) higher on average than those without “Bruce Willis” Further, tags or the like stored in user data 123 could include ratings, e.g., on a scale of 1 to 5, 1 to 10, or the like. Ratings for various tags in respective items of derivative content 125 could be totaled or averaged to provide an overall rating for an item of derivative content 125. Alternatively or additionally, the system may rank lower on average scenes that are described by clip-level metadata 105 to include “Nicholas Cage” because the collected user data 123 indicates that the user changes channels away from programming that includes “Nicholas Cage”.

Next, in a block 810, the items of derivative content 125 are selected from the ranked list generated in the block 805. Generally a predetermined number of items of derivative content 125 may be selected. For example, where ten (10) trailers are generated, the top three (3) may be selected for presentation to the user.

Next, in a block 815, the selected items of derivative content 125 are displayed by the media device 120, e.g., presented on the display 121. The items of derivative content 125 may be played in an order based on their rankings, or they may be presented in a list from which a user may select items of derivative content 125 for playback. Where such a list is presented, a greater number of items of derivative content 125, e.g., all that were ranked, more than three, etc., may be presented, e.g., in rank order, such that a user may scroll through the list to select an item of derivative content 125 that is of interest for playback.

The process 800 ends following the block 815.

FIG. 9 is a diagram of an exemplary process 900 for rating derivative content 125.

The process 900 begins in a block 905 in which an item of derivative content 125, or at least a portion thereof, is displayed by media device 120. The entirety of an item of derivative content 125 need not be viewed by a user in order to provide feedback for rating the item of derivative content 125. For example, if the user dislikes a movie trailer immediately, the user may halt playback of the trailer item of derivative content 125, resulting in a low rating for the item of derivative content 125. On the other hand, if a user purchases a movie based on a partial viewing of a trailer, this relatively quick purchase may provide a high score for a trailer item of derivative content 125 without it being viewed in its entirety.

Next, in a block 910, media device 120 may request a rating from the user. This request may include a message presented on display device 121 and/or and audio indication (a chime sound or a prerecorded request). Requesting a rating from a user may include displaying a rating question. The rating question may include, for example, a request for rating the item of derivative content 125 on a 1 to 10 scale. The user may then push a button on the remote control to provide a numeric input (e.g., 0 . . . 9) or may push a button (such as the “arrow up” button) to increase the number of stars associated with a trailer item of derivative content 125. Alternatively, the question such as “did you like the trailer?” may be displayed with a yes or no prompt. The user may then respond using the arrow keys to select either “yes” or “no”.

Further, the block 910 could include capturing a user evaluation such as a rating for a particular segment or clip within an item of derivative content 125. For example, the user could identify a favorite portion, or a portion that the user likes, by traversing to a portion of a video shown on a display 121, and then providing a rating for that video segment, i.e., portion of an item of derivative content 125.

Next, in a block 915, the response to the rating question is logged at media device 120, and is generally included in collected user data 123.

Next, in a block 920, the response may be reported back to media source 101 for analysis. Alternatively, media device 120 may collect a number of rating responses before reporting back to media source 101.

The process 900 ends following the block 920.

### CONCLUSION

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A media device that includes a processor and a memory, the memory storing instructions executable by the processor, the instructions including instructions for:
identifying an indicia of user interest in at least one media content attribute;
identifying at least one segment of an item of media content that is associated with the indicia of interest; and
generating an item of derivative content that includes the at least one segment.

2. The media device of claim 1, the instructions further including instructions for including content in the derivative content that is additional content with respect to the item of media content.

3. The media device of claim 1, wherein the at least one segment included in the derivative content includes mandatory content.

4. The media device of claim 1, the instructions further including instructions for storing the derivative content at the media device for selective playback upon receiving a user request.

5. The media device of claim 1, the instructions further including instructions for:
gathering the indicia of user interest based on at least one of a user input, user data obtained from a media source, usage history of the media device, and a user account at a remote site;
and storing user data that includes the indicia of interest.

6. The media device of claim 1, the instructions further including instructions for:
generating and storing a plurality of items of derivative content, each of the items of derivative content related to one of: the item of media content and a second item of media content;
ranking the items of derivative content;
providing the items of derivative content for user selection according to the ranking.

7. The media device of claim 1, the instructions further including instructions for receiving, from a media source, the item of media content and clip-level metadata that specifies the at least one segment in the item of media content that is associated with the indicia of interest.

8. The media device of claim 1, wherein the derivative content comprises a movie trailer.

9. A media source system that includes at least one computing device comprising a processor and a memory, the memory storing instructions executable by the processor, the instructions including instructions for:
providing an item of media content to a first media device;
receiving, from the media device, and storing data to recreate derivative content; wherein the derivative content includes at least one segment extracted from the item of media content by the first media device;
storing an indicia of user interest in at least one attribute associated with the derivative content;
identifying a second media device based at least in part of the indicia of user interest; and
providing the data sufficient to recreate the derivative content to the second media device.

10. The system of claim 9, the instructions further including instructions for providing to the first media device, along with the first item of media content, at least one of data indicating a location in the item of media content associated with the at least one attribute and data concerning a mandatory segment to be included in the derivative content.

11. The system of claim 9, the instructions further including instructions for providing to the first media device, along with the first item of media content, additional content for inclusion in the derivative content.

12. The system of claim 9, the instructions further including instructions for receiving, from at least one of the first media device and the second media device, a rating for the derivative content.

13. A method, comprising:
identifying, in a computer that includes a memory and a processor, an indicia of user interest in at least one media content attribute;
identifying at least one segment of an item of media content that is associated with the indicia of interest; and
generating an item of derivative content that includes the at least one segment.

14. The method claim 13, further comprising including content in the derivative content that is additional content with respect to the item of media content.

15. The method claim 13, wherein the at least one segment included in the derivative content includes mandatory content.

16. The method claim 13, further comprising storing the derivative content at the media device for selective playback upon receiving a user request.

17. The method claim 13, further comprising:
gathering the indicia of user interest based on at least one of a user input, user data obtained from a media source, usage history of the media device, and a user account at a remote site;
and storing user data that includes the indicia of interest.

18. The method claim 13, further comprising:
generating and storing a plurality of items of derivative content, each of the items of derivative content related to one of: the item of media content and a second item of media content;
ranking the items of derivative content;
providing the items of derivative content for user selection according to the ranking.

19. The method claim 13, further comprising receiving, from a media source, the item of media content and clip-level metadata that specifies the at least one segment in the item of media content that is associated with the indicia of interest.

20. The method claim 13, wherein the derivative content comprises a movie trailer.
